(19) United States
(12) Patent Application Publication
(10) Pub. No.: US 2014/0032401 A1
(43) Pub. Date: Jan. 30, 2014

(54) METHOD OF HIGH SPEED DOWNLOADING

(71) Applicant: GREEN BEANS COFFEE COMPANY USA, LLC, LARKSPUR, CA (US)

(72) Inventors: H. Jason ARAGHI, Mill Valley, CA (US); Brian Laliberte, Novato, CA (US)

(73) Assignee: GREEN BEANS COFFEE COMPANY USA, LLC, LARKSPUR, CA (US)

(21) Appl. No.: 13/949,352

(22) Filed: Jul. 24, 2013

Related U.S. Application Data
(60) Provisional application No. 61/676,295, filed on Jul. 26, 2012.

(51) Int. Cl. H04W 48/02; G06Q 20/14

(52) U.S. Cl. CPC H04W 48/02; G06Q 20/145
USPC 705/39; 709/225

(57) ABSTRACT

The disclosure relates to a method of providing digital content wirelessly using a communications portal with restricted access to navigation over the Internet. The method may include enabling high speed downloads over the communications portal using one or more address maps of data links for downloadable digital content. The method may include publishing an interface to a wireless device, wherein the interface provides a finite set of selections that are associated with at least one or more of the address maps. The method may also include collecting and distributing fees based on downloads of digital content.

### CROSS REFERENCE TO RELATED APPLICATION

This application claims the benefit of U.S. Provisional Patent Application No. 61/676,295 filed Jul. 26, 2012, which application is hereby incorporated by reference for all purposes in its entirety.

### BACKGROUND OF THE DISCLOSURE

1. Field of Disclosure

The present disclosure relates to providing high speed downloads of selected content, and, in particular, providing high speed downloads using a closed platform.

2. Description of the Related Art

Internet hot spots in places of business, such as coffee shops, cafés, malls and airports, are commonly used to provide wireless device users with access to the Internet without the customer using his cellular network for data communication. The wireless device users may then navigate the Internet as if they were connected over a cellular data network, or if capable, over a hard line connection. Typically, a wireless device user receives limited data speeds and unlimited access when using an Internet hot spot to access the Internet. When accessing digital content for downloading, the wireless device user accesses a digital content provider's website, which may include links, redirections, and pop-ups that navigate the wireless devices to web addresses that are irrelevant to or inefficient for downloading of the digital content.

In order to manage the data usage by large numbers of wireless devices, often accessing links that are not part of the digital content downloading, hot spot administrators restrict the bandwidth and data speeds of the wireless device users while allowing the users to navigate the Internet freely. However, these restricted data speeds are often too slow for effective downloading of large digital files (such as movies) where the user may have a small window to perform downloading and streaming is not an option (e.g. a short layover in an airport). What is needed is a method of downloading at high speed in a wireless hot spot environment that does not overburden bandwidth and data usage speeds available to the Internet hot spot.

### BRIEF SUMMARY OF THE DISCLOSURE

In aspects, the present disclosure is related to a method of providing high speed downloads of selected content, and, in particular, providing high speed downloads using a closed platform.

One embodiment according to the present disclosure includes a method of providing limited access to digital content over the Internet, the method comprising: providing wireless access to a communications portal configured to restrict external access to one or more approved content providers, wherein the communications portal comprises an address map for each of the one or more approved providers; providing a download of digital content of the one or more approved content providers via an internet connection to a wireless device, wherein the downloading only uses data links in the address map associated with at least one of the one or more approved content providers.

The communications portal may be an electronic closed platform that includes a software system configured to restrict access to non-approved content. The method may also include steps for building the address map for each of the one or more approved content providers; and storing the one or more address maps in the communications portal. Each of the address maps may include a plurality of data links associated with the digital content of one of the one or more approved content providers. The method may also include updating at least one of the address maps. The method may also include providing a set of the one or more approved content providers via an interface published over an electronic communications medium to the wireless device. The electronic communications medium may include one of: a web browser and a software application. The interface may include at least one link associated with at least one of the set of the one or more approved content providers. Each member of the set may be obligated to pay a fee for inclusion in the set. The fee may be based on at least one of: i) approved content provider revenue for the downloaded digital content and ii) inclusion of the approved content provider in the interface. The digital content may include one or more of: i) an e-book, ii) a magazine, iii) an audio file, iv) a movie, v) an software game, vi) news, and vii) digital entertainment. The user of the wireless device is only obligated to pay each of the one or more approved content providers for the downloaded digital content.

Another embodiment according to the present disclosure includes a method of providing digital content, the method comprising: providing access to at least one approved content provider to a user through a communications portal configured to use at least one Internet address map comprising a plurality of data links associated with the at least one approved content provider; and downloading digital content from the at least one approved content provider to a user wireless device using only addresses in the at least one Internet address map.

The method may also include steps for: constructing the at least one Internet address map; and storing the at least one Internet address map in the communications portal. The method may also include updating the at least one Internet address map. The method may also include placing a selectable link on an interface accessible to the wireless device for each of the set of the approved content providers. Each of the content providers is obligated to pay a fee to an administrator of the communications portal when that content provider's digital content is purchased by a user of the wireless device. The fee may be based on at least one of: i) an amount paid for the purchased digital content and ii) inclusion in the set. The web content may include one or more of: i) an e-book, ii) a magazine, iii) an audio file, iv) a movie, v) a game, vi) news, and vii) digital entertainment. The access to the web content may be provided through an electronic communication medium. The communications portal may be an electronic closed platform.

Another embodiment according to the present disclosure includes a method of managing revenue from digital content purchases, the method comprising: supplying at least one address map to at least one communications portal, wherein the at least one address map comprises a plurality of data links associated with digital content download addresses, and wherein the at least one communications portal is configured to restrict access of wireless devices to at least one approved content provider using the at least one address map; monitoring downloads on the at least one communications portal, wherein the monitoring includes tracking purchases made from the wireless devices to the at least one approved content provider associated with the at least one address map; and receiving a fee from the at least one approved content provider.

The fee may be based on an amount of the tracked purchases. The method may also include a step of constructing the at least one address map. The method may also include a step of distributing at least part of the fee to an administrator of the communications portal.

### BRIEF DESCRIPTION OF DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a system for generating a user interface according to one embodiment of the present disclosure;

FIG. 2 shows a schematic for fast digital content download system according to one embodiment of the present disclosure;

FIG. 3 shows an interface screen for navigation of the user interface according to one embodiment of the present disclosure;

FIG. 4 shows a flow chart of a method of fast downloading according to one embodiment of the present disclosure;

FIG. 5 shows a diagram of a downloading system with an aggregator according to one embodiment of the present disclosure;

FIG. 6 shows a diagram of a downloading system without an aggregator according to one embodiment of the present disclosure;

FIG. 7 shows a flow chart of a method of providing fast downloads according to one embodiment of the present disclosure; and

FIG. 8 shows a flow chart of a method of distributing revenue for a fast downloading system according to one embodiment of the present disclosure.

### DETAILED DESCRIPTION OF THE DISCLOSURE

Generally, the present disclosure relates to providing high speed downloads of selected content, and, in particular, providing high speed downloads using a closed platform. Specifically, the present disclosure is related to administration and operations of a closed platform that supports a revenue model enabling customers to download content at high speeds from content providers with a select status. The select status of a content provider, which may be fee-based, allows the potential content providers to be restricted to a finite number that may be managed by a portal administrator. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

When accessing the website of an affiliate, only some of the data links will be required for downloading selected digital content. Herein, digital content includes, but is not limited to, one or more of: documents, data, applications, e-services, images, audio files, video files, URLs, packaged files, compressed files, and zipped files. The extraneous links may redirect to wireless device to other Internet addresses that consume bandwidth and reduce data speeds. A closed platform may be used restrict access users with wireless devices to only the data links required for downloading the selected digital content, thus making the downloading more efficient and enabling higher download speeds. The closed platform may include one or more maps of data links associated with digital content of selected affiliates and restrict digital wireless devices operating on the closed platform to the one or more data link maps. In some embodiments, the closed platform may store maps of data links for a non-affiliate (a party is a potential future or former affiliate that is not accessible to the user until the party becomes an affiliate). The data link maps may include web addresses, applications, URLs, and other locators or pointers for web or cloud based data. The data link maps may be constructed (manually, using an automated processes, or a combination thereof) and stored for use by the closed platform, which serves as a portal for the wireless device user to download digital content from one or more of the approved content providers (“affiliates”).

Each of the affiliates may be party to a predetermined relationship with the administrator of a communications portal based on the closed platform. Unique identifiers (links, icons, messages, etc.) may be used to identify each affiliate and affiliate offer for digital content. The affiliate-administrator links may be managed by the administrator or at a higher level aggregator. In some embodiments an aggregator may establish or provide affiliate-administrator links and monitor usage. In some embodiments, an aggregator may manage and/or monitor data flow and transactions for multiple portal administrators. Usage monitoring, purchase history, or both may be used to determine affiliate fees that may be paid to the administrator and, if present, the aggregator.

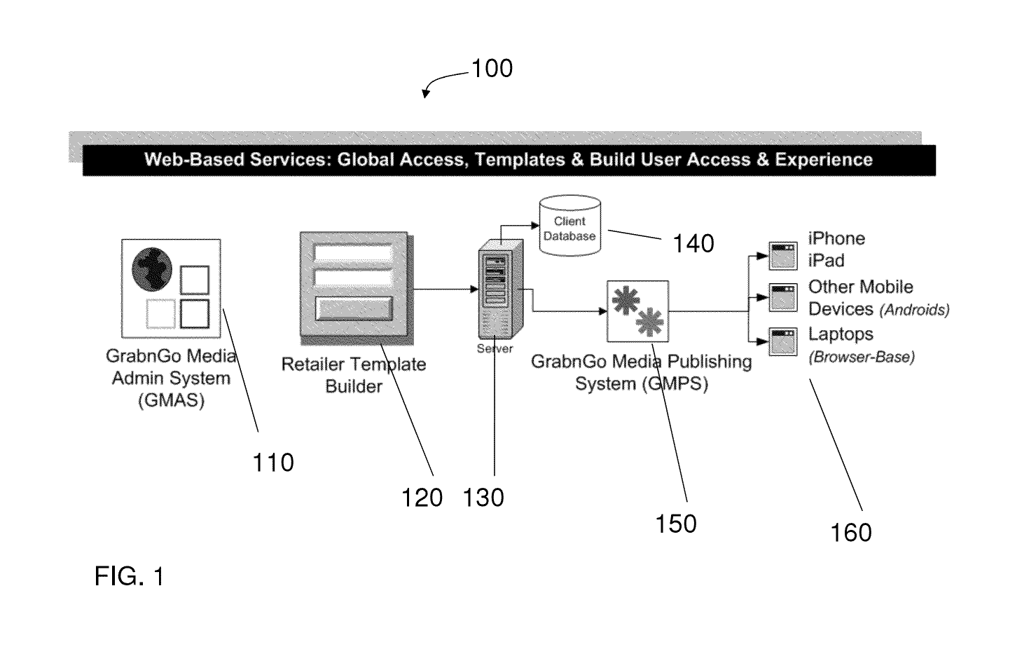

FIG. 1 shows a schematic diagram of communications portal 100 according to one embodiment of the present disclosure. The communications portal 100 may be configured to allow a party to construct or maintain a portal interface configured to enable downloading of digital content by users operating wireless devices 160. The wireless devices may be any wireless enabled electronic communications device as understood by a person of ordinary skill in the art including, but not limited to, mobile devices (mobile phones, smart phones, personal digital assistants, smart glasses, smart watches, etc.), tablet computers, laptops, wireless enabled desktop computers, televisions, and cameras. The communications portal 100 may include an administration system 110, an interface builder tool 120, a server 130, a client database 140, and a publishing system 150. The administration system 110 may include access rules and links that govern the content that is accessible and restricted on the closed platform (portal). The restrictions may include limits imposed on navigation to external websites. The administrator system 110 may also be configured to link digital content of affiliates (approved content providers) to an interface. The administrator system 110 may also be configured to provide one or more of: i) password protection, ii) dedicated template maintenance for wireless device users, iii) dedicated template maintenance for affiliates, iv) maintaining links between affiliates and wireless device customers, and v) adding, removing, disabling, and maintaining one or more Portal Administrators.

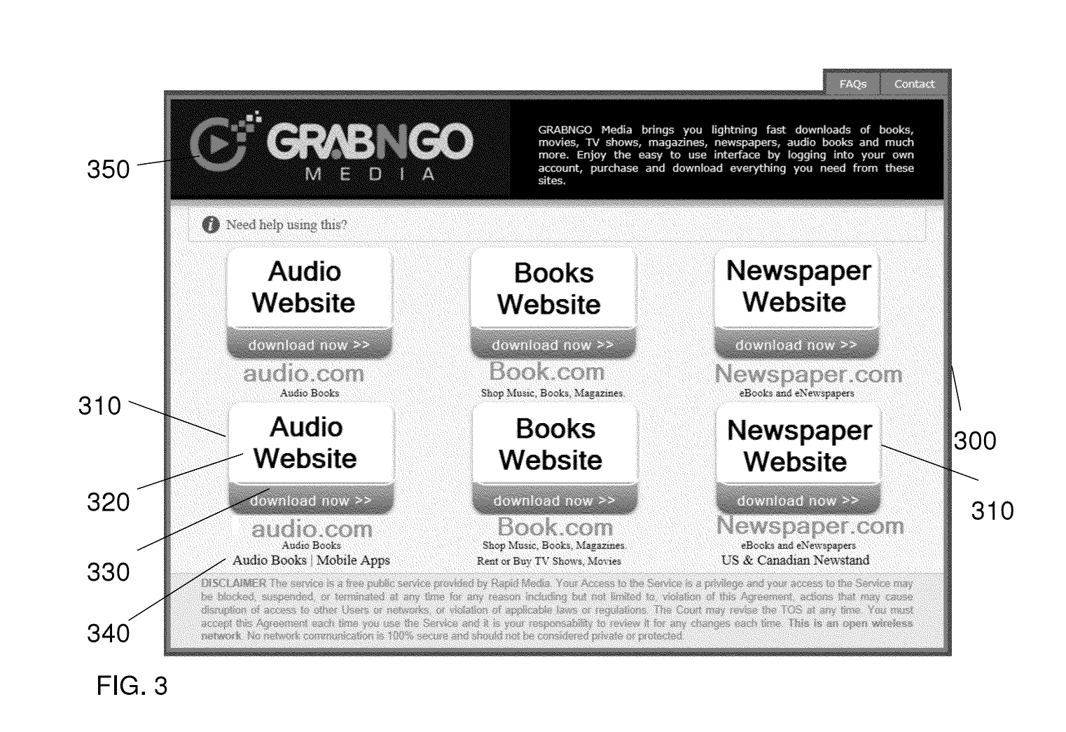

The interface builder tool 120 may be configured to enable the portal administrator to construct the interface. The interface 300 (FIG. 3) may include links to the digital content that is accessible to the wireless device user over an electronic communication medium, including, but not limited to, one or more of: a web browser and smart phone application. The position and display of the links in the interface 300 may be modified using the administrator system 110. The server 130 may be configured to operate the interface 300 and, upon activation of one of the links on the interface 300, to direct the wireless digital device to the website or digital file location of an affiliate. A client database 140 may be accessed by the server 130 and configured to store the interface and maps of data links to digital content associated with affiliates. The maps of data links may be constructed by the portal administrator, the aggregator, or another party. The publishing system 150 may be configured to publish the interface 300 to one or more electronic communication media accessible to the digital wireless device 160. The interface 300 may include a set of icons representing one or more of the affiliates. The selection of which affiliates are shown on interface 300 may be selected using the administrator system 110. The publishing system 150 may be configured to publish digital content to specific wireless devices 160.

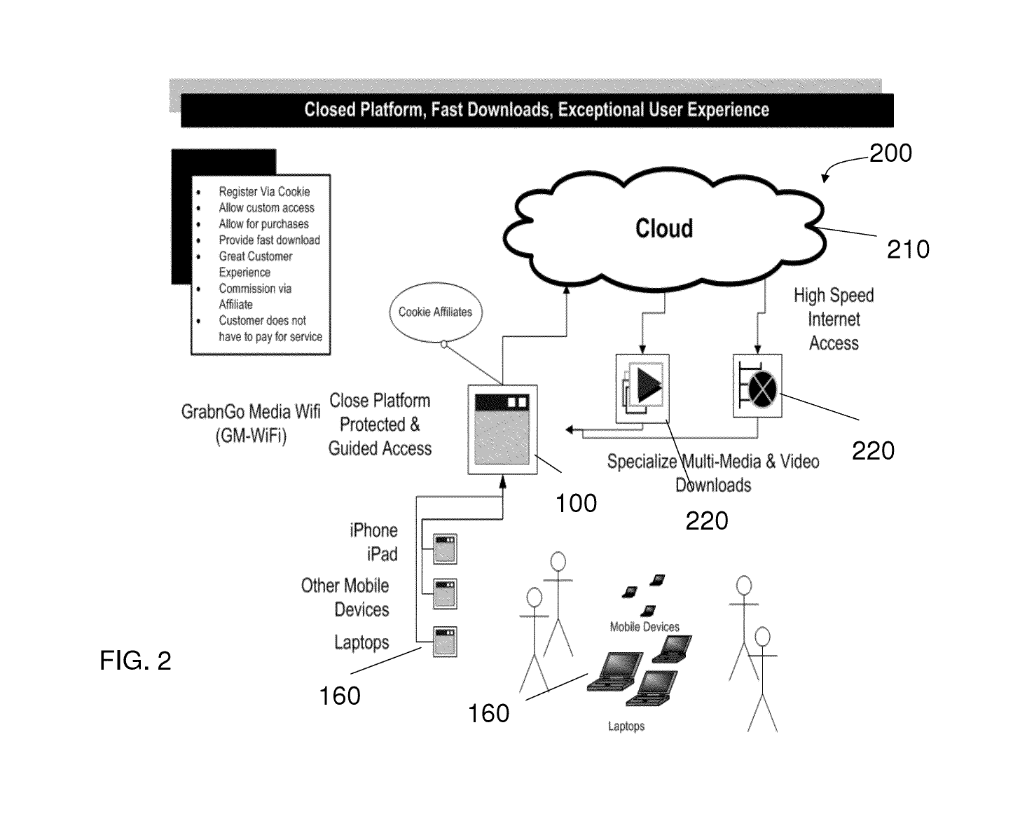

FIG. 2 shows a schematic of a high speed download system 200 according to one embodiment of the present disclosure. The one or more of the wireless devices 160 may access the communications portal 100 which provides restricted access to the affiliate digital content in the cloud computing environment 210 as understood by one of skill in the art. Digital content from the cloud (or data network) 210 that is selected by the wireless device 160 may be retrieved as a high speed Internet download 220 which is directed to the wireless device 160 through the communications portal 100.

FIG. 3 shows an interface 300 according to one embodiment of the present disclosure. The interface 300 may be published to the wireless devices 160 over one or more electronic communications media. The interface 300 may include one or more links to that may be activated by the wireless device user to access affiliate content. Each link may direct the electronic communication media to additional web addresses or pointers, however, the wireless device will be limited to links that are part of the approved map for that particular affiliate. As shown in FIG. 3, the links may includes icons 310 which may include an identification section 320 that displays a name of the affiliate and a clickable section 330 that initiates downloading or further navigation. The interface 300 may also include descriptions 340 associated with one or more of the icons 310 that identify the type of content available from the affiliate. The positions of the icons 310 may be controlled by the portal administrator. The interface 300 may also include a banner 350 that may identify one or more of the aggregator, portal administrator, and sponsor of the communications portal 100. The component parts of the icons 310 and their arrangement on interface 300 are illustrative and exemplary only, as the icons 310 may be displayed in other ways, such as with URL addresses, which are understood by persons of ordinary skill in the art.

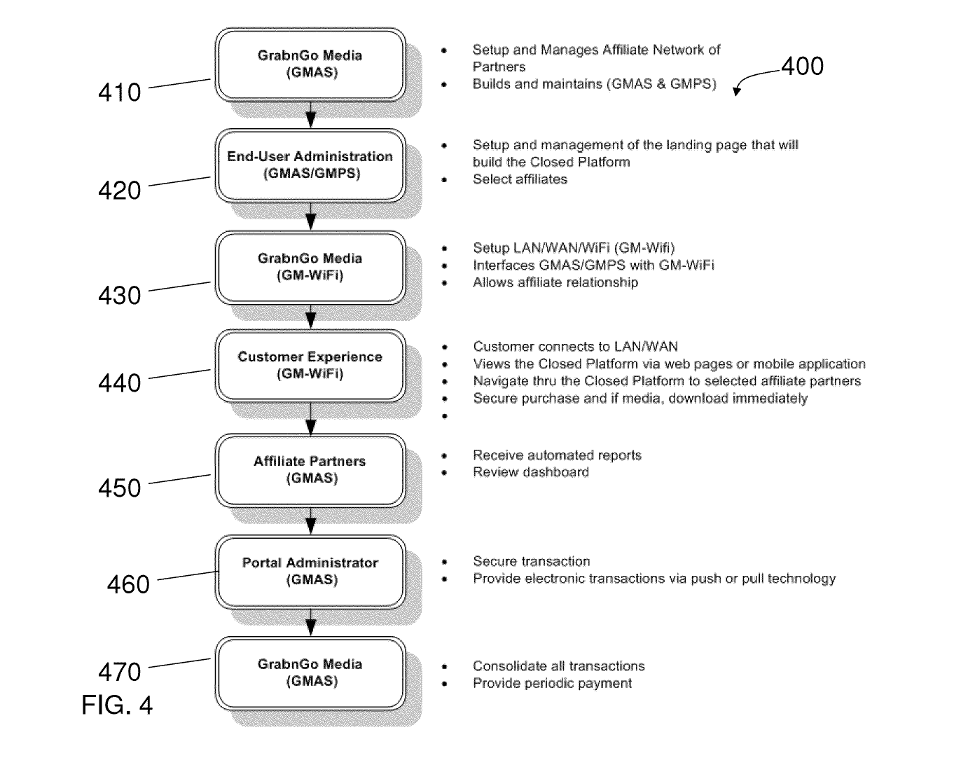

FIG. 4 is a flow chart of a method 400 of operating the communications portal 100 according to one embodiment of the present disclosure. In step 410, the communication portal 100 is set up by the portal administrator. In step 420, the interface 300 is setup by the portal administrator, including selections of affiliates represented on the interface 300. In step 430, the maps of data links enabling the high speed downloads may be set up by the portal administrator. In some embodiments, the maps of data links may be obtained from an aggregator or a third party. In step 440, the wireless device operator (customer) may connect to the communications portal 100. In some embodiments, connection may include supplying a login ID and password. Once connected, the wireless device operator may be able to search the affiliate's available digital content for selection, purchase, and/or download. The wireless device operator may make a purchase and commence downloading of digital content. The wireless device operator is obligated to pay for the purchase of the digital content, as designated by the affiliate, but not the price of the high speed download service. In step 450, the affiliate may be supplied with data related to usage (downloading of digital content, site visits, etc.) by the aggregator or the portal administrator. In step 460, the portal administrator may prepare a record of the transaction and transmit that record to the aggregator. In step 470, the aggregator may consolidate the transactions. In some embodiments, the aggregator may consolidate all of the transactions for a specific affiliate, bill the specific affiliate and collect the fees due to according to the affiliate-portal administrator agreement. In some embodiments, the aggregator may make distribution of the collected fees to the portal administrator. In some embodiments, the aggregator may extract a service fee from the collected fees and distribute the balance to the portal administrator. Fees from the affiliates may be used to compensate the portal administrators and aggregators for maintenance of the high speed downloading system. In some embodiments, there may be a many to one relationship between the affiliates and the aggregator and a many to one relationship between portal administrators and the aggregator.

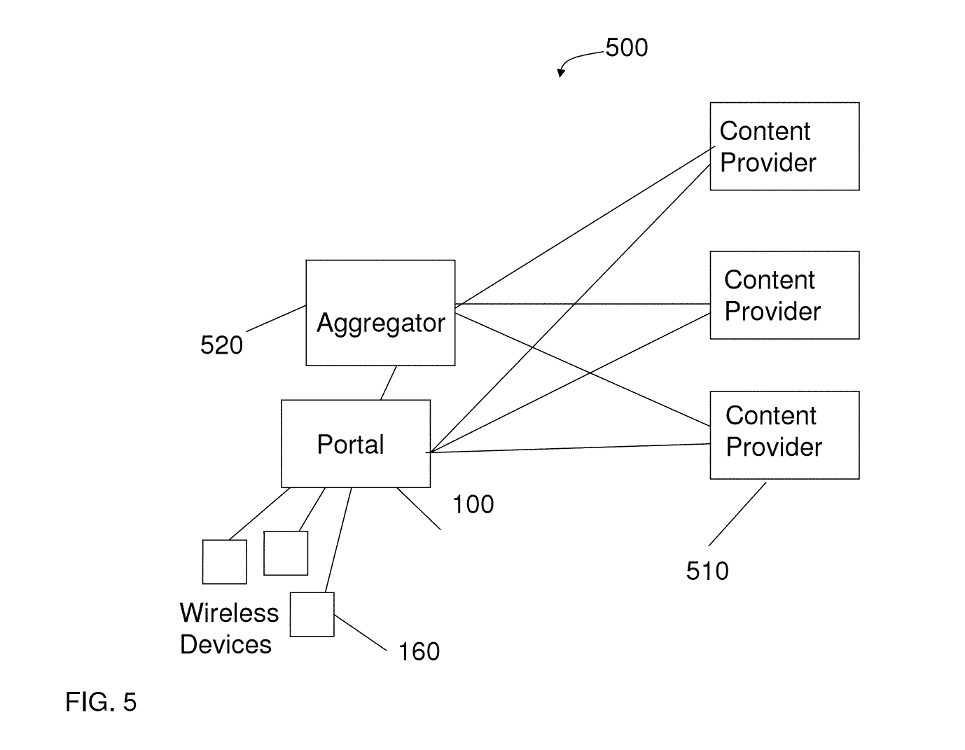

FIG. 5 shows a diagram of a digital content download system 500 according to one embodiment of the present disclosure. The system 500 includes the communications portal 100 that supplies wireless communication with the wireless devices 160. The communications portal 100 is also in communication with an aggregator 520 and one or more content providers 510. Data communication between the aggregator 520 and the content providers 510 may be wired or wireless. Data communication between the communications portal 100 and the aggregator 520 may also be wired or wireless. The aggregator 520 may be configured to supply address maps for use by the communications portal 100 and to monitor communications portal activity with regard to purchases made from content providers 510. While only a single communications portal 100 is shown, the aggregator 520 may operate in a many to one relationship with a plurality of communication portals 100. When multiple communication portals 100 are present, the aggregator 520 may supply identical or different sets of address maps to individual communication portals 100. Thus, the aggregator 520 may be configured to maintain a set of address maps, however, each communications portal 100 may only have access to a subset of these address maps. The subsets may be the same or different.

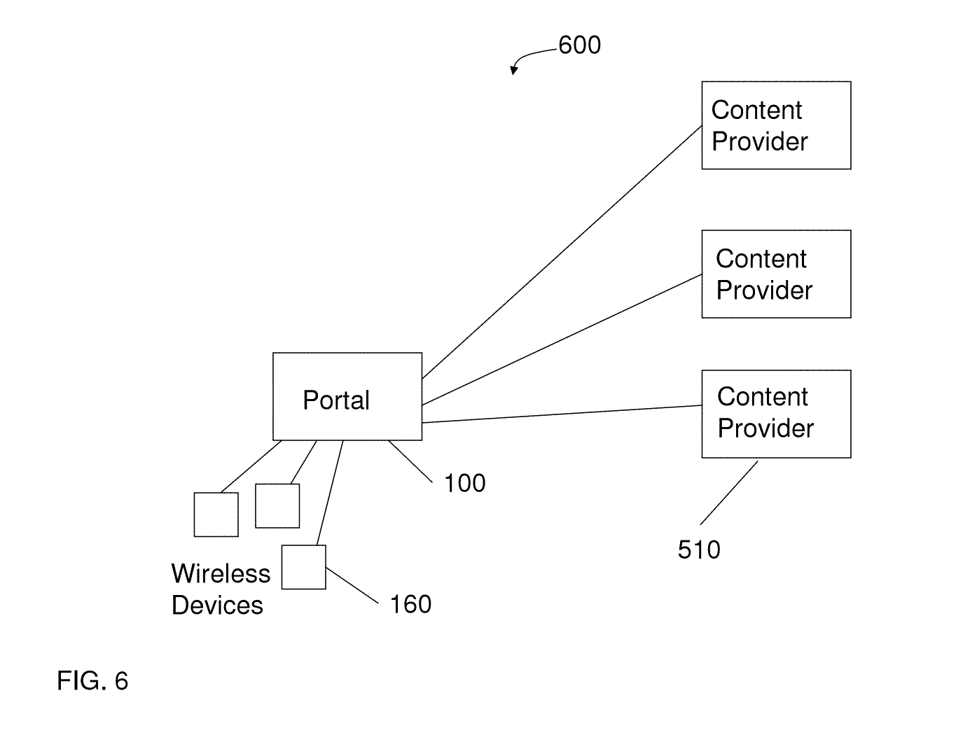

FIG. 6 shows diagram of another digital content download system 600 according to one embodiment of the present disclosure. The system 600 may include the communications portal 100 that supplies wireless communications with the wireless devices 160. System 600 differs from system 500, in that communications portal 100 may perform the role of aggregator as well as access to content provider digital content and download capability.

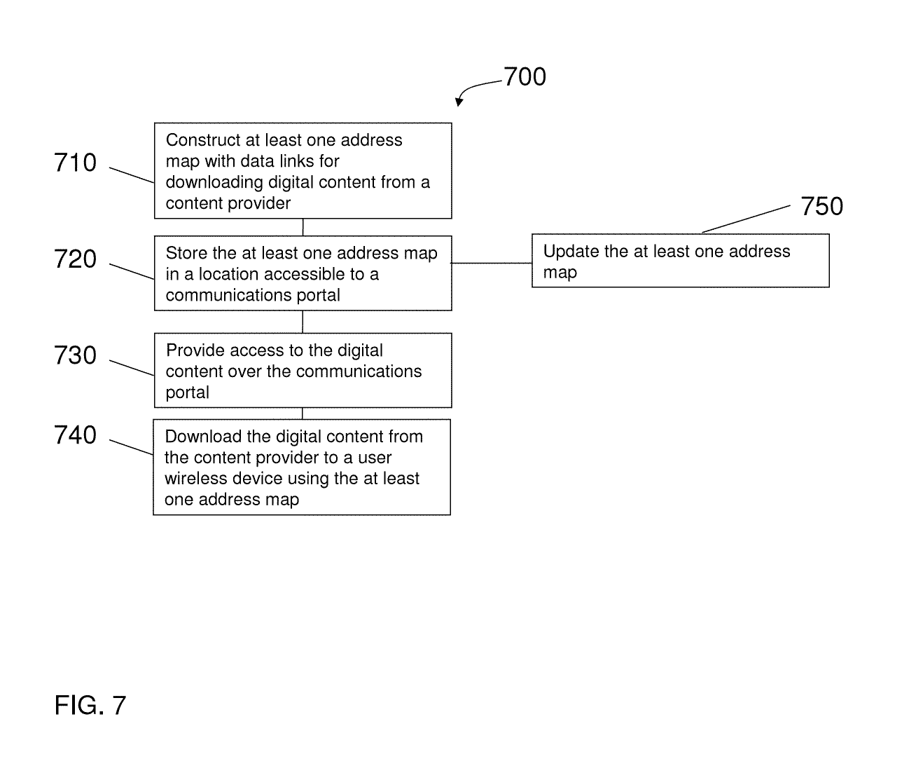

FIG. 7 shows a flow chart of a method 700 according to one embodiment of the present disclosure. In step 710, at least one address map including data links for downloading digital content from a content provider may be constructed. In step 720, the at least one address map may be stored in a location in or accessible to a communications portal 100. In some embodiments, the administrator system 110, the server 130, or the client database 140 within the communication portal 100 may be used to store address maps. In step 730, access to digital content from content providers 510, 610 may be provided to the wireless devices 160 over communications portal 100. The wireless devices 160 may receive a published interface 300 generated by publishing system 150. The user of the wireless device 160 may navigate the content provider's digital content and elect to make a purchase. In step 740, the purchased digital content may be downloaded to the wireless device 160 from the content provider 510, 610 using the communications portal 100 to restrict downloading to data links that are part of an address map for that digital content and content provider. In step 750, the address maps may be updated periodically. Step 750 may be optional or performed by a third party. In some embodiments, steps 710 and 720 may be optional for the communications portal administrator or performed by a third party or the aggregator 520.

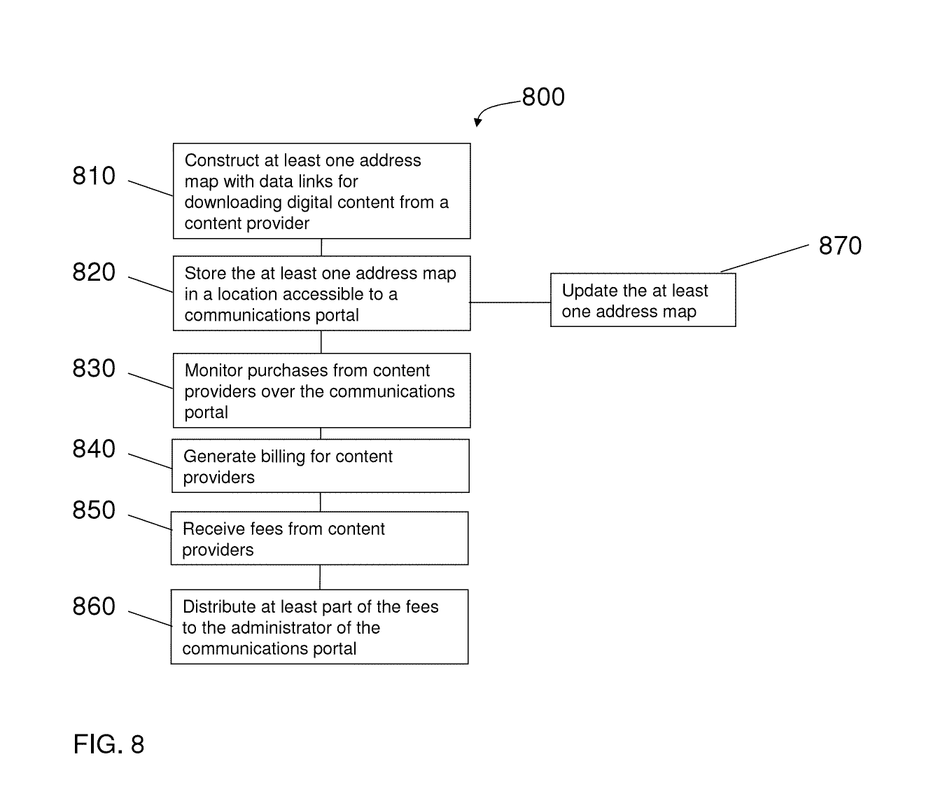

FIG. 8 shows a flow chart of a method 800 according to one embodiment of the present disclosure. In step 810, at least one address map including data links for downloading digital content from a content provider may be constructed. In step 820, the at least one address map may be stored in a location in or accessible to a communications portal 100. In some embodiments, the administrator system 110, the server 130, or the client database 140 within the communication portal 100 may be used to store address maps. In step 830, purchase transactions over communications portal 100 between wireless device users and content providers 510, 610 may be monitored. The purchase transactions may be monitored by the communications portal 100 and/or the aggregator 520. In some embodiments, the monitoring may include the purchase price of the digital content in the transactions. In step 840, billing of fees for the content providers 510, 610 may be prepared. In some embodiments, the billing amount may be based on the purchase price of the transactions. In step 850, the aggregator 520 or administrator of the communications portal 100 may receive fees from the content providers 510, 610. The fees may be based on the appearance of the content providers' inclusion in communications portal 100 for fast downloading, value of purchases from the content provider, or both. In step 860, at least part of the fees may be distributed to the administrator of the communications portal 100. Step 860 is generally performed when step 850 is performed by the aggregator 520. In step 870, the address maps may be updated periodically. Step 870 may be performed by the administrator of the communications portal 100, the aggregator 520, or a third party.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of providing limited access to digital content over the Internet, the method comprising:
providing wireless access to a communications portal configured to restrict external access to one or more approved content providers, wherein the communications portal comprises an address map for each of the one or more approved providers;
providing a download of digital content of the one or more approved content providers via an internet connection to a wireless device, wherein the downloading only uses data links in the address map associated with at least one of the one or more approved content providers.

2. The method of claim 1, wherein the communications portal is an electronic closed platform.

3. The method of claim 1, wherein the communications portal comprises a software system configured to restrict access to non-approved content.

4. The method of claim 1, further comprising:
building the address map for each of the one or more approved content providers; and
storing the one or more address maps in the communications portal.

5. The method of claim 1, wherein each of the address maps comprises:
a plurality of data links associated with the digital content of one of the one or more approved content providers.

6. The method of claim 1, further comprising:
providing a set of the one or more approved content providers via an interface published over an electronic communications medium to the wireless device.

7. The method of claim 6, wherein the electronic communications medium comprises at least one of: a web browser and a software application.

8. The method of claim 6, wherein the interface comprises at least one link associated with at least one of the set of the one or more approved content providers.

9. The method of claim 6, wherein each member of the set is obligated to pay a fee for inclusion in the set.

10. The method of claim 9, wherein the fee is based on at least one of: i) approved content provider revenue for the downloaded digital content and ii) inclusion of the approved content provider in the interface.

11. The method of claim 1, wherein the digital content comprises at least one of: i) an e-book, ii) a magazine, iii) an audio file, iv) a movie, v) an software game, vi) news, and vii) digital entertainment.

12. The method of claim 1, wherein a user of the wireless device is only obligated to pay each of the one or more approved content providers for the downloaded digital content.

13. The method of claim 1, further comprising:
updating at least one of the address maps.

14. A method of providing digital content, the method comprising:
providing access to at least one approved content provider to a user through a communications portal configured to use at least one Internet address map comprising a plurality of data links associated with the at least one approved content provider; and
downloading digital content from the at least one approved content provider to a user wireless device using only addresses in the at least one Internet address map.

15. The method of claim 14, further comprising:
constructing the at least one Internet address map; and
storing the at least one Internet address map in the communications portal.

16. The method of claim 14, further comprising:
updating the at least one Internet address map.

17. The method of claim 14, wherein the providing access step comprises:
placing a selectable link on an interface accessible to the wireless device for each of the set of the approved content providers.

18. The method of claim 17, wherein the each of the content providers is obligated to pay a fee to an administrator of the communications portal when that content provider's digital content is purchased by a user of the wireless device.

19. The method of claim 18, wherein the fee is based on at least one of: i) an amount paid for the purchased digital content and ii) inclusion in the set.

20. The method of claim 14, wherein the web content comprises at least one of: i) an e-book, ii) a magazine, iii) an audio file, iv) a movie, v) a game, vi) news, and vii) digital entertainment.

21. The method of claim 14, wherein the access to the web content is provided through an electronic communication medium.

22. The method of claim 14, wherein the communication portal is an electronic closed platform.

23. A method of managing revenue from digital content purchases, the method comprising:
supplying at least one address map to at least one communications portal, wherein the at least one address map comprises a plurality of data links associated with digital content download addresses, and wherein the at least one communications portal is configured to restrict access of wireless devices to at least one approved content provider using the at least one address map;
monitoring downloads on the at least one communications portal, wherein the monitoring includes tracking purchases made from the wireless devices to the at least one approved content provider associated with the at least one address map; and
receiving a fee from the at least one approved content provider.

24. The method of claim 23, wherein the fee is based on an amount of the tracked purchases.

25. The method of claim 23, further comprising:
constructing the at least one address map.

26. The method of claim 23, further comprising:
distributing at least part of the fee to an administrator of the communications portal.
